(19) United States
(12) Patent Application Publication
(10) Pub. No.: US 2024/0191798 A1
(43) Pub. Date: Jun. 13, 2024

(54) POSITIONING ARRANGEMENT FOR POSITIONING A SHEET METAL ELEMENT ON A FLANGE JOINT

(71) Applicant: DEUTZ Aktiengesellschaft, Koeln (DE)

(72) Inventors: Martin SCHNEIDER, Windeck (DE); Oliver SCHMITZ, Huerth (DE); Viktor SCHLIDT, Bergheim (DE)

(21) Appl. No.: 18/286,262

(22) PCT Filed: Apr. 6, 2022
(86) PCT No.: PCT/EP2022/000035

§ 371 Date: Oct. 10, 2023

(30) Foreign Application Priority Data
Apr. 14, 2021 (DE) 102021001942.3

(51) Int. Cl. F16J 15/08

(52) U.S. Cl. CPC F16J 15/0831; F16J 2015/085

(57) ABSTRACT

A positioning arrangement for positioning a sheet metal element on a flange joint includes a flange with a medium passage opening, and a mating flange with a medium passage opening. The mating flange is connected to the flange with a plurality of fastening screws and the respective medium passage openings of the flange and the mating flange communicate with each other. The positioning arrangement also includes a sheet metal element with an abutment section. The abutment section is arranged in an abutment plane between the flange and the mating flange around the medium passage openings. The sheet metal element also includes at least three first tabs, which are arranged at a first through-hole of the sheet metal element and project transversely to the abutment plane into a first receiving hole in the mating flange. The at least three first tabs are received with radial clearance in the first receiving hole. The sheet metal element is positioned relative to the flange via the first tabs

The present disclosure relates to a positioning arrangement for positioning a sheet metal element on a flange joint. The positioning arrangement comprises a flange with a medium passage opening and a mating flange with a medium passage opening, the mating flange being connected to the flange with a plurality of fastening screws, and the respective medium passage openings of the flange and the mating flange communicating with each other. Furthermore, the positioning arrangement comprises a sheet metal element with an abutment section which is arranged in an abutment plane between the flange and the mating flange in a sealing manner around the medium passage openings, and with first tabs which are arranged at a first through-hole of the sheet metal element and project transversely to the abutment plane into a first receiving hole in the mating flange.

### BACKGROUND

Such a positioning arrangement in the form of a sealing arrangement is known from DE 10 2017 214 662 A1, wherein a sheet metal element in the form of a flat gasket comprises two fastening arrangements, each with two tabs that engage in corresponding fastening holes in the mating flange. To prevent the flat gasket from being loosened unintentionally when preassembled on the mating flange, the tabs each comprise projections at their respective ends that engage form-fittingly behind undercuts in the fastening holes. Radial recesses are provided in the fastening holes for the tabs to engage, so that the fastening screws are centered by the fastening holes and remain unaffected by the tabs.

Furthermore, conventional flat gaskets without tabs are known, which are only held to the flange and the mating flange via through-holes and fastening screws. Here, however, due to large tolerances and a narrow sealing section, the flat gasket sometimes can shift to such an extent that leaks can occur. In the case of very flat flat gaskets in particular, there is also a risk that the flat gasket will be shifted laterally in the area of the through-holes, thereby entering a thread of a fastening screw, such that the flat gasket will be shifted laterally even further than merely within the manufacturing and assembly tolerances.

### SUMMARY

An objective of the present disclosure is to provide a positioning arrangement that ensures reliable positioning of a sheet metal element and is simple in design.

The objective is solved by a positioning arrangement for positioning a sheet metal element on a flange joint, wherein the positioning arrangement comprises a flange with a medium passage opening and a mating flange with a medium passage opening. The mating flange is connected to the flange via several fastening screws and the medium passage openings of the flange and the mating flange communicate with each other. Furthermore, the positioning arrangement comprises a sheet metal element with an abutment section which is arranged in an abutment plane between the flange and the mating flange in a sealing manner around the medium passage openings, and with first tabs which are arranged at a first through-hole of the sheet metal element and project transversely to the abutment plane into a first receiving hole in the mating flange. The sheet metal element comprises at least three first tabs that are received with radial clearance in the first receiving hole. The sheet metal element is positioned via the first tabs on a first one of the fastening screws, which extends through the first receiving hole and through the first through-hole and is threaded into a threaded bore in the flange, and the sheet metal element is thereby positioned relative to the flange via the first tabs.

For example, the positioning arrangement may be a sealing arrangement in which the sheet metal element is a flat gasket that seals the medium passage between the respective medium passage openings of the flange and the mating flange. In this case, the abutment section serves as a sealing section, which can additionally be provided with a circumferential sealing bead or a circumferential sealing element, for example made of an elastomer. Such a sealing arrangement can, for example, be arranged in an exhaust tract of an internal combustion engine.

The sheet metal element may also be another element, such as an orifice plate, a choke, or a baffle. The medium passage can serve for the passage of different media, i.e. gaseous media, such as exhaust gases or the like, or liquid media, such as cooling liquids or the like.

The three first tabs center the sheet metal element relative to a longitudinal axis of the first fastening screw. Since the first fastening screw is screwed into the threaded bore of the flange, the sheet metal element is also positioned with respect to the flange, so that no further elements need to be provided as positioning aids, such as locating pins and locating holes.

It may be provided that the radial clearance of the first tabs relative to the first receiving hole is greater than a radial clearance of the first tabs relative to the first fastening screw.

In order to ensure further secure positioning of the sheet metal element relative to the flange, according to one embodiment the sheet metal element can comprise a second through-hole at which two diametrically opposed second tabs are arranged, which extend transversely to the abutment plane into a second receiving hole in the mating flange with a radial clearance. In this case, the sheet metal element is positioned via the two second tabs on a second one of the fastening screws, which is passed through the second receiving hole and through the second through-hole and is screwed into a threaded bore in the flange, and the sheet metal element is thereby positioned relative to the flange. In this regard, the second tabs are further disposed on opposite sides of a first connecting plane that includes a first longitudinal axis of the first fastening screw and a second longitudinal axis of the second fastening screw.

This ensures that the sheet metal element is supported against rotation about the first longitudinal axis of the first fastening screw via the second tabs relative to the flange.

The first and/or the second receiving hole can be formed cylindrical.

It may be provided that, transverse to the first connecting plane, the radial clearance of the second tabs relative to the second receiving hole is greater than a radial clearance of the second tabs relative to the second fastening screw.

In another embodiment, the mating flange has a first positioning hole via which the mating flange is positioned on one of the fastening screws that extends through the first positioning hole and through a through-hole of the sheet metal element and is threaded into a threaded bore in the flange, and thereby is positioned relative to the flange.

Thus, in addition to positioning the sheet metal element relative to the flange via the first fastening screw, positioning of the mating flange relative to the flange via one of the fastening screws is also ensured. This means that the mating flange is positioned relative to the flange independently of the sheet metal element.

According to a first alternative, the mating flange can be positioned with the first positioning hole on a third one of the fastening screws, which is passed through a third through-hole of the sheet metal element and screwed into a threaded bore in the flange. The positioning of the mating flange relative to the flange is thus achieved independently of the positioning of the sheet metal element via another of the fastening screws.

According to a second alternative, the mating flange may be positioned with the first positioning hole on the first fastening screw. The mating flange is thus positioned relative to the flange via the same fastening screw as the sheet metal element. Herein, the first receiving hole and the first positioning hole are to be arranged coaxially to each other, so that the first receiving hole and the first positioning hole are each formed as a hole section of a common longitudinal hole. The diameter of the first receiving hole is to be dimensioned larger than the diameter of the first positioning hole, resulting in a stepped longitudinal hole.

The radial clearance of the first tabs in the first receiving hole may be greater than a radial clearance of the fastening screw in the first positioning hole.

This ensures that when the mating flange is shifted parallel to the abutment plane, it is always radially supported via the fastening screw in the first positioning hole without the first tabs abutting the inner wall of the first receiving hole.

The mating flange may further include a second positioning hole, the mating flange being positioned on one of the fastening screws, which extends through the second positioning hole and through a through-hole of the sheet metal element and is threaded into a threaded bore in the flange, and the mating flange being thereby positioned relative to the flange. The second positioning hole is formed as an elongated hole with a longest diameter and a shortest diameter in the abutment plane, with the longest diameter directed towards the first positioning hole.

Herein, according to a first alternative, the mating flange with the second positioning hole can be positioned on a fourth one of the fastening screws, which extends through a fourth through-hole of the sheet metal element and is screwed into a threaded bore in the flange.

According to a second alternative, the mating flange can also be positioned with the second positioning hole on the second fastening screw. The mating flange is thus positioned relative to the flange via the same fastening screw as the sheet metal element. In this case, the second receiving hole and the second positioning hole are to be arranged coaxially with one another, so that the second receiving hole and the second positioning hole are each formed as a hole section of a common longitudinal hole. The diameter of the second receiving hole is to be dimensioned larger than the diameter of the second positioning hole, resulting in a stepped longitudinal hole.

A radial clearance of the fastening screw in the second positioning hole transverse to a second connecting plane, which includes a longitudinal axis of the fastening screw in the first positioning hole and a longitudinal axis of the fastening screw in the second positioning hole, may be dimensioned smaller than a radial clearance of the second tabs within the second receiving hole transverse to the first connecting plane.

This ensures that if the mating flange is rotated relative to the flange, the flange is always radially supported via the fastening screw in the second positioning hole without the second tabs abutting the inner wall of the second receiving hole. This means that the mating flange is also positioned against rotation relative to the flange, independently of the sheet metal element.

The term “radial clearance” refers to a gap between the respective fastening screw or the respective tabs and the respective receiving hole or positioning hole, regardless of whether or not displacement of the fastening screw within the respective receiving hole or positioning hole to this extent is possible at all.

In order to prevent the sheet metal element from reaching radially into a thread of a fastening screw when it is shifted in the abutment plane, which would increase the radial clearance of the sheet metal element, it can be provided that the tabs are longer transverse to the abutment plane than the thread pitch of the respective fastening screw. In particular, the lengths of the tabs may be at least 1.2 times the thread pitch of the respective fastening screw.

### BRIEF SUMMARY OF THE DRAWINGS

A preferred embodiment is explained in more detail below with reference to the drawings. Herein

FIG. 1 shows an exploded view of a positioning arrangement,

FIG. 2 shows a top view of the first fastening arrangement of the positioning arrangement according to FIG. 1,

FIG. 3 shows a top view of the second fastening arrangement of the positioning arrangement according to FIG. 1,

FIG. 4 shows a top view of the third fastening arrangement of the positioning arrangement according to FIG. 1 and

FIG. 5 shows a top view of the fourth fastening arrangement of the positioning arrangement according to FIG. 1.

### DETAILED DESCRIPTION

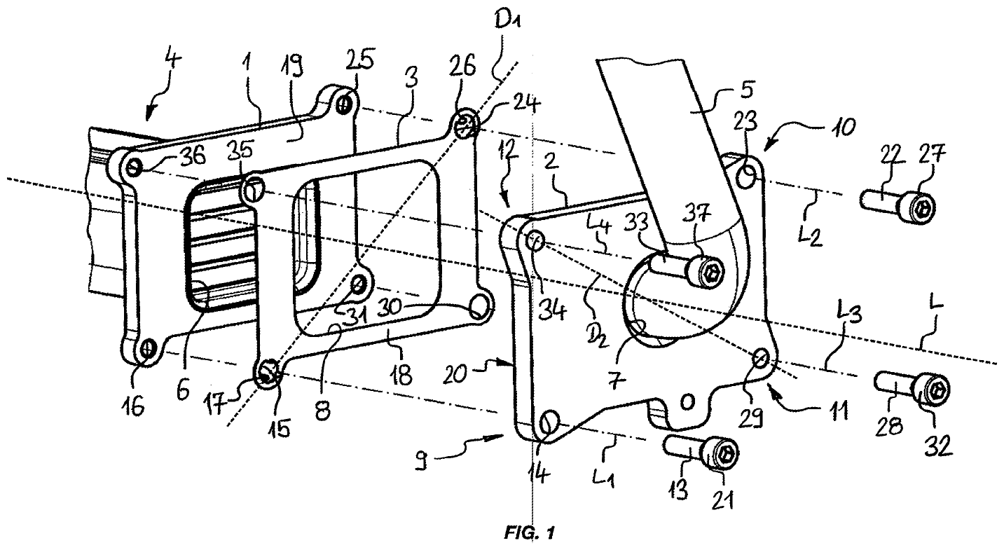

FIG. 1 shows an exploded view of an embodiment of a positioning arrangement with a flange 1 to which a mating flange 2 is attached, wherein a sheet metal element 3 is arranged between the flange 1 and the mating flange 2. The sheet metal element 3 is made of a metallic material and serves as a flat gasket. In the embodiment shown, the flange 1 is part of an EGR (exhaust gas recirculation) cooler 4 of an combustion engine, in particular an internal combustion engine. Via the flange 1, the EGR cooler 4 is connected in terms of lines to an EGR line 5, which is provided with the mating flange 2. For this purpose, the flange 1 of the EGR cooler 4 has a medium passage opening 6 to allow exhaust gas from the EGR cooler 4 to pass through. The mating flange 2 also has a medium passage opening 7, which is connected in terms of lines to the EGR line 5, resulting in a medium passage.

For sealing this medium passage to the outside, the sheet metal element 3 has an abutment section 18, which in the present embodiment serves as a sealing section and also forms a medium passage opening 8, so that the abutment section 18 is arranged in a sealing manner between the flange 1 and the mating flange 2 in an abutment plane transverse to a longitudinal axis L of the sealing arrangement. In this case, the abutment section 18 is in sealing contact with a sealing surface 19 around the medium passage opening 6 of the flange 1 and a sealing surface 20 arranged around the medium passage opening 7 of the mating flange 2. The sealing surfaces 19, 20 face each other and are also arranged in the abutment plane and receive the sheet metal element 3 between them.

In the embodiment shown, the mating flange 2 is connected to the flange 1 via a first fastening arrangement 9, a second fastening arrangement 10, a third fastening arrangement 11, and a fourth fastening arrangement 12.

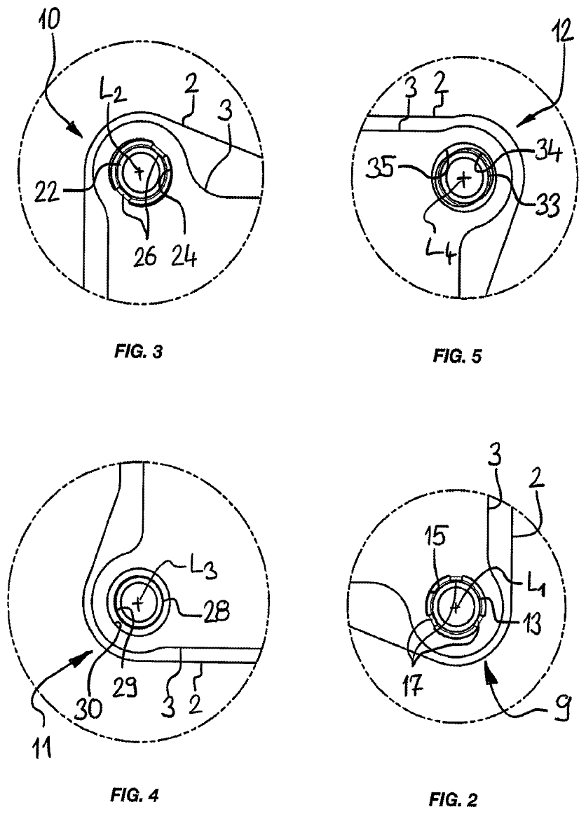

The first fastening arrangement 9 is also shown in an enlarged top view of the sheet metal element 3 and in the direction of the mating flange 2 in FIG. 2. The first fastening arrangement 9 includes a first fastening screw 13, a first receiving bore hole 14 in the mating flange 2, a first through-hole 15 in the sheet metal element 3, and a first threaded bore 16 in the flange 1. The first fastening screw 13 is guided through the first receiving hole 14 and through the first through-hole 15 along a first longitudinal axis L1, which is arranged parallel to the longitudinal axis L of the positioning arrangement, and is screwed into the first threaded bore 16. Herein, the first fastening screw 13 is supported axially via a screw head 21 on a side of the mating flange 2 facing away from the flange 1 and thus biases the mating flange 2 against the flange 1, thereby bracing the sheet metal element 3 between the flange 1 and the mating flange 2.

In the shown embodiment, three first tabs 17 are connected to the abutment section 18 of the sheet metal element 3 and are arranged at the first through-hole 15 and are uniformly distributed around the first longitudinal axis L1 in the shown embodiment example. There may also be more than three first tabs 17. In principle, the first tabs 17 can also be unevenly distributed. The tabs 17 can be an integral part of the sheet metal element 3, i.e. formed integrally with the abutment section 18. The first tabs 17 may be bent over by a forming process and extend transversely to the abutment plane. Alternatively, the first tabs 17 could also be part of a separate component, for example a sleeve, which is connected to the abutment section 18.

The first tabs 17 project transversely to the abutment plane into the first receiving hole 14 of the mating flange 2, with the fastening screw 13 passing between the first tabs 17 through the first through-hole 15. Thus, the sheet metal element 3 is centered and positioned on the first fastening screw 13 via the first tabs 17. The fact that at least three first tabs 17 are provided ensures that the sheet metal element 3 is centered on the first fastening screw 13. Furthermore, the sheet metal element 3 is thus positioned relative to the flange 1.

In order to prevent the sheet metal element 3 from reaching into a thread of the first fastening screw 13, when the sheet metal element 3 is shifted in the abutment plane, and from increasing a clearance of the sheet metal element 3 in the abutment plane, the first tabs 17 are dimensioned to be longer transversely to the abutment plane than the thread pitch of the first fastening screw 13. This means that the first tabs 17 are longer than the distance between two threads of the first fastening screw 13, so that the first tabs 17 are always radially supported on tips of the threads of the first fastening screw 13.

Furthermore, in the embodiment shown, the mating flange 2 is connected to the flange 1 via a second fastening arrangement 10.

The second fastening arrangement 10 is also shown in an enlarged top view of the sheet metal element 3 and in the direction of the mating flange 2 in FIG. 3. The second fastening arrangement 10 includes a second fastening screw 22, a second receiving bore hole 23 in the mating flange 2, a second through-hole 24 in the sheet metal element 3, and a second threaded bore 25 in the flange 1. The second fastening screw 22 is guided through the second receiving hole 23 and the second through-hole 24 along a second longitudinal axis L2, which is arranged parallel to the longitudinal axis L of the positioning arrangement, and is screwed into the second threaded bore 25. The second fastening screw 22 is thus also supported axially against the mating flange 2 via a screw head 27.

In the present embodiment, two second tabs 26 are connected to the abutment section 18 of the sheet metal element 3, which may be identical in design to the first tabs 17. In principle, however, the second tabs 26 can also have a different shape than the first tabs 17. For example, they can be made wider for a larger contact area with the second fastening screw 22. The second tabs 26 project axially transversely from the abutment plane into the second receiving hole 23. In this case, the two second tabs 26 are arranged on opposite sides of a connecting plane, which is indicated by a diagonal D1 in FIG. 1 and includes the first longitudinal axis L1 of the first fastening screw 13 and the second longitudinal axis L2 of the second fastening screw 22. The sheet metal element 3 is positioned on the second fastening screw 22 via the second tabs 26. Thus, the sheet metal element 3 is also positioned exactly relative to the flange 1.

Furthermore, in the embodiment shown, the mating flange 2 is connected to the flange 1 via a third fastening arrangement 11.

In principle, however, it is also conceivable that only the first fastening arrangement 9 and the second fastening arrangement 10 are provided. In this case, the mating flange is positioned relative to the flange via the same fastening screw as the sheet metal element. In this case, the first receiving hole and the first positioning hole as well as the second receiving hole and the second positioning hole are to be arranged coaxially to each other, so that the receiving holes and the positioning holes are each formed as a bore section of a common longitudinal bore. The diameter of the receiving holes should be larger than the diameter of the respective positioning hole, resulting in stepped longitudinal holes.

The third fastening arrangement 11 is also shown in an enlarged top view of the sheet metal element 3 and in the direction of the mating flange 2 in FIG. 4. The third fastening arrangement 11 includes a third fastening screw 28, a first positioning bore hole 29 in the mating flange 2, a third through-hole 30 in the sheet metal element 3, and a third threaded bore 31 in the flange 1. The third fastening screw 28 is passed through the first positioning hole 29 and the third through-hole 30 along a third longitudinal axis L3, which is parallel to the longitudinal axis L of the positioning arrangement, and is screwed into the third threaded bore 31. The third fastening screw 28 is also supported axially against the mating flange 2 via a screw head 32. In contrast to the first fastening arrangement 9 and the second fastening arrangement 10, no tabs are arranged at the third through-hole 30 of the sheet metal element 3. In the embodiment shown, the third through-hole 30 has an enlarged diameter compared to the first positioning hole 29, and the first positioning hole 29 is formed cylindrical. The mating flange 2 is centered on the third fastening screw 28 via the first positioning hole 29 and is thus positioned relative to the flange 1.

Furthermore, in the embodiment shown, the mating flange 2 is connected to the flange 1 via a fourth fastening arrangement 12.

The fourth fastening arrangement 12 is also shown in an enlarged top view of the sheet metal element 3 and in the direction of the mating flange 2 in FIG. 5. The fourth mounting arrangement 12 includes a fourth fastening screw 33, a second positioning bore hole 34 in the mating flange 2, a fourth through-hole 35 in the sheet metal element 3, and a fourth threaded bore 36 in the flange 1. The fourth fastening screw 33 is passed through the second positioning hole 34 and the fourth through-hole 35 along a fourth longitudinal axis L4, which is parallel to the longitudinal axis L of the positioning arrangement, and is screwed into the fourth threaded bore 36. The fourth fastening screw 33 is also supported axially against the mating flange 2 via a screw head 37. Like the third fastening screw 28, the fourth fastening arrangement 12 comprises a fourth through-hole 35 on the sheet metal element 3 without tabs. The second positioning hole 34 is formed as an elongated hole with a longest diameter directed towards the first positioning hole 29. The mating flange 2 is thus also positioned via the second positioning hole 34 on the fourth fastening screw 33 and thereby relative to the flange 1.

In the embodiment shown, the first receiving hole 14 and the second receiving hole 23 are identically formed, i.e. they have an identical diameter. The first positioning hole 29 has a diameter that is smaller than the first receiving hole 14 and the second receiving hole 23. For example, the diameter of the first positioning hole 29 may correspond approximately to the distance between the two second tabs 26 or to an inside diameter circumscribed by the first tabs 17. The first positioning hole 29, like the first receiving hole 14 and the second receiving hole 23, is formed cylindrical. The second positioning hole 34 is designed as an elongated hole that extends with a longest diameter in the direction of a further connecting plane indicated by the diagonal D2 in FIG. 1. The other connecting plane includes the third longitudinal axis L3 and the will longitudinal axis L4.

### LIST OF REFERENCE SIGNS

1 Flange
2 Mating flange
3 Sheet metal element
4 EGR cooler
5 EGR line
6 Medium passage opening
7 Medium passage opening
8 Medium passage opening
9 First fastening arrangement
10 Second fastening arrangement
11 Third fastening arrangement
12 Fourth fastening arrangement
13 First fastening screw
14 First receiving hole
15 First through-hole
16 First threaded bore
17 First tab
18 Abutment section
19 Sealing surface
20 Sealing surface
21 Screw head
22 Second fastening screw
23 Second receiving hole
24 Second through-hole
25 Second threaded bore
26 Second tab
27 Screw head
28 Third fastening screw
29 First positioning hole
30 Third through-hole
31 Third threaded bore
32 Screw head
33 Fourth fastening screw
34 Second positioning hole
35 Fourth through-hole
36 Fourth threaded bore
37 Screw head

1-11. (canceled)

12: A positioning arrangement for positioning a sheet metal element on a flange joint comprising:
a flange with a medium passage opening;
a mating flange with a medium passage opening, the mating flange being connected to the flange with a plurality of fastening screws and the respective medium passage openings of the flange and the mating flange communicating with each other; and
a sheet metal element with an abutment section, the abutment section being arranged in an abutment plane between the flange and the mating flange around the medium passage openings, the sheet metal element including at least three first tabs arranged at a first through-hole of the sheet metal element and projecting transversely to the abutment plane into a first receiving hole in the mating flange,
the at least three first tabs being received with radial clearance in the first receiving hole,
the sheet metal element being positioned via the at least three first tabs on a first one of the fastening screws, which is passed through the first receiving hole and through the first through-hole and is screwed into a first threaded bore in the flange, the sheet metal element being positioned relative to the flange via the at least three first tabs,
the sheet metal element comprises a second through-hole at which two diametrically opposite second tabs are arranged which are extending transversely with respect to the abutment plane and project with radial clearance into a second receiving hole in the mating flange,
the sheet metal element being positioned via the two second tabs on a second one of the fastening screws, which is passed through the second receiving hole and through the second through-hole and is screwed into a second threaded bore in the flange, the sheet metal element being positioned relative to the flange via the two second tabs,
the second tabs being arranged on opposite sides of a first connecting plane which includes a first longitudinal axis of the first fastening screw and a second longitudinal axis of the second fastening screw.

13: The positioning arrangement according to claim 12, wherein the radial clearance of the at least three first tabs relative to the first receiving hole is greater than a radial clearance of the at least three first tabs relative to the first fastening screw.

14: The positioning arrangement according to claim 12, wherein transversely to the first connecting plane, the radial clearance of the second tabs relative to the second receiving hole is greater than a radial clearance of the second tabs relative to the second fastening screw.

15: The positioning arrangement according to claim 12, wherein the mating flange comprises a first positioning hole, the mating flange being positioned on one of the fastening screws, which is passed through the first positioning hole and through a through-hole of the sheet metal element and is screwed into a third threaded bore in the flange, via the first positioning hole and the mating flange being positioned with respect to the flange via the first positioning hole.

16: The positioning arrangement according to claim 15, wherein the mating flange is positioned via the first positioning hole on a third of the fastening screws, which is passed through a third through-hole of the sheet metal element and is screwed into a threaded bore in the flange, or
the mating flange is positioned via the first positioning hole on the first fastening screw.

17: The positioning arrangement according to claim 15, wherein the radial clearance of the at least three first tabs in the first receiving hole is larger than a radial clearance of the fastening screw in the first positioning hole.

18: The positioning arrangement according to claim 15, wherein the mating flange has a second positioning hole, the mating flange being positioned via the second positioning hole on one of the fastening screws, which is passed through the second positioning hole and through a through-hole of the sheet metal element and is screwed into a threaded bore in the flange, and the mating flange being positioned via the second positioning hole relative to the flange, and the second positioning hole is formed as an elongated hole with a longest diameter and a shortest diameter in the abutment plane, the longest diameter being orientated towards the first positioning hole.

19: The positioning arrangement according to claim 18, wherein that the mating flange is positioned with the second positioning hole on a fourth of the fastening screws, which is passed through a fourth through-hole of the sheet metal element and is screwed into a threaded bore in the flange, or the mating flange is positioned with the second positioning hole on the second fastening screw.

20: The positioning arrangement according to claim 13, wherein a radial clearance of the fastening screw in the second positioning hole transversely to a second connecting plane, which includes a longitudinal axis of the fastening screw in the first positioning hole and a longitudinal axis of the fastening screw in the second positioning hole, is smaller than a radial clearance of the second tabs within the second receiving hole transversely to the first connecting plane.

21: The positioning arrangement according to claim 12, wherein the first and second tabs are longer transversely to the abutment plane than a thread pitch of the respective fastening screw.
